(19) United States
(12) Patent Application Publication
(10) Pub. No.: US 2021/0314179 A1
(43) Pub. Date: Oct. 7, 2021

(54) METHODS AND CONSENSUS NODES FOR BLOCK GENERATION

(71) Applicant: ALIPAY (HANGZHOU) INFORMATION TECHNOLOGY CO., LTD., Hangzhou (CN)

(72) Inventor: Xiaojun LIAO, HANGZHOU (CN)

(21) Appl. No.: 17/353,185

(22) Filed: Jun. 21, 2021

(30) Foreign Application Priority Data
Jul. 3, 2020 (CN) 202010629690.2

(51) Int. Cl. H04L 9/32

(52) U.S. Cl. CPC H04L 9/3297; H04L 2209/38; H04L 9/3265; H04L 9/3239

(57) ABSTRACT

A method and a consensus node for block generation are provided. The method includes: initiating a target consensus proposal carrying a first timestamp provided by the first consensus node; receiving the target consensus proposal; determining a second timestamp based on a time that the target consensus proposal is received; verifying the first timestamp based on a third timestamp of a local ending block of the second consensus node and the second timestamp; if successfully verifying the first timestamp, executing consensus logic on the target consensus proposal to reach a consensus with the first consensus node regarding the target consensus proposal; and generating a new block recording data of the target consensus proposal, wherein the generated new block comprises a fourth timestamp that is determined based on at least the first timestamp and is not earlier than timestamps of existing local blocks the first consensus node and the second consensus node.

### CROSS-REFERENCE TO RELATED APPLICATION

This application is based on and claims priority to and benefits of Chinese Patent Application No. 202010629690.2, filed with the China National Intellectual Property Administration (CNIPA) on Jul. 3, 2020. The entire content of the above-identified application is incorporated herein by reference.

### TECHNICAL FIELD

This document relates to the field of blockchain technologies, and in particular, to a method and a consensus node for block generation.

### BACKGROUND

In a blockchain system, timestamps of all blocks need to be sequentially increasing like block numbers. At present, the vast majority of blockchain systems adopt a Byzantine Fault Tolerance (BFT) consensus protocol. In the BFT consensus protocol, a timestamp of a block is determined by a proposal initiator. If the proposal initiator is malicious, temporal orderliness of an entire chain of blocks is destroyed. In addition, for some blockchain services that require time tracing, service decisions can be executed only when timestamps of blocks are correct.

For this reason, currently there is an urgent need for a technical solution to ensure that a timestamp of a new block increases progressively with respect to a timestamp of a previous block.

### SUMMARY

Embodiments of this specification provide a method and a consensus node for block generation. This can ensure that a timestamp of a new block increases progressively with respect to a timestamp of a previous block.

In order to achieve the foregoing objective, embodiments of this specification are implemented in the following manner.

According to a first aspect, a method for block generation is provided, including:

initiating, by a first consensus node of a blockchain, a target consensus proposal carrying a first timestamp provided by the first consensus node;

determining, by a second consensus node of the blockchain after receiving the target consensus proposal, a second timestamp based on a time that the target consensus proposal is received;

performing, by the second consensus node, verification on the first timestamp based on a third timestamp of a local ending block and the second timestamp, to execute consensus logic on proposal data of the target consensus proposal after the verification succeeds; and

generating, by the first consensus node and the second consensus node if a consensus is reached on the target consensus proposal, a new block recording the proposal data of the target consensus proposal, where a fourth timestamp of the generated new block is obtained through determining based on at least the first timestamp, and is not earlier than timestamps of other local blocks of a consensus node to which the new block belongs.

In an embodiment, a method for block generation is provided. The method comprises: initiating, by a first consensus node of a blockchain, a target consensus proposal carrying a first timestamp provided by the first consensus node; receiving, by a second consensus node of the blockchain from the first consensus node, the target consensus proposal; determining, by the second consensus node, a second timestamp based on a time that the target consensus proposal is received; verifying, by the second consensus node, the first timestamp based on a third timestamp of a local ending block of the second consensus node and the second timestamp; in response to successfully verifying the first timestamp, executing, by the second consensus node, consensus logic on the target consensus proposal to reach a consensus with the first consensus node regarding the target consensus proposal; and generating, by the first consensus node and the second consensus node, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

In an embodiment, the initiating, by a first consensus node of a blockchain, a target consensus proposal carrying a first timestamp provided by the first consensus node comprises: obtaining, by the first consensus node, a fifth timestamp related to a current time and a sixth timestamp of a local ending block of the first consensus node; and if the fifth timestamp is later than the sixth timestamp, using the fifth timestamp as the first timestamp and initiating the target consensus proposal carrying the first timestamp, or if the fifth timestamp is earlier than the sixth timestamp, determining the first timestamp by adding a unit time to the sixth timestamp and initiating the target consensus proposal carrying the first timestamp.

In an embodiment, the verifying, by the second consensus node, the first timestamp comprises: verifying that the first timestamp is earlier than the second timestamp and later than the third timestamp.

In an embodiment, the first consensus node and the second consensus node adopt a consensus protocol based on a Honey Badger Byzantine Fault Tolerance algorithm; the generated new block comprises a plurality of consensus proposals on which consensuses are reached in a consensus stage of the Honey Badger Byzantine Fault Tolerance algorithm, the plurality of consensus proposals including the target consensus proposal and a consensus proposal initialed by the second consensus node; and the fourth timestamp is determined based on a plurality of timestamps of the plurality of consensus proposals, the plurality of timestamps comprising the first timestamp.

In an embodiment, the fourth timestamp is a median value of the plurality of timestamps.

In an embodiment, the verifying, by the second consensus node, the first timestamp occurs after a reliable broadcast (RBC) protocol stage of the Honey Badger Byzantine Fault Tolerance algorithm is completed and before a binary agreement (BA) protocol stage is entered.

In an embodiment, the method further comprises: in response to the first timestamp not being successfully verified, setting, by the second consensus node, a BA value of the target consensus proposal in a BA protocol stage to 0 to cause a failure to reach a consensus on the target consensus proposal.

In an embodiment, the blockchain adopts a consensus protocol of a practical Byzantine Fault Tolerance algorithm, the first consensus node is a primary consensus node of the blockchain, and the fourth timestamp is equal to the first timestamp.

In an embodiment, the verifying, by the second consensus node, the first timestamp occurs in a pre-prepare stage or a prepare stage of the practical Byzantine Fault Tolerance algorithm.

According to a second aspect, a consensus node of a blockchain is provided, including:

a timestamp obtaining module, configured to determine, after a target consensus proposal initiated by another consensus node of the blockchain is received, a second timestamp based on a time that the target consensus proposal is received, where the target consensus proposal carries a first timestamp provided by the another consensus node;

a consensus execution module, configured to perform verification on the first timestamp based on a third timestamp of a local ending block and the second timestamp, to execute consensus logic on proposal data of the target consensus proposal after the verification succeeds;

a block generation module, configured to generate, if a consensus is reached on the target consensus proposal, a new block recording the proposal data of the target consensus proposal, where a fourth timestamp of the generated new block is obtained through determining based on at least the first timestamp, and is not earlier than timestamps of other local blocks; and

a consensus initiation module, configured to: if a consensus proposal needs to be initiated based on a consensus protocol of the blockchain, initiate a consensus proposal carrying a locally provided timestamp.

According to a third aspect, a system for block generation is provided. The system comprises one or more processors and a non-transitory computer-readable storage medium storing instructions executable by the one or more processors to cause the system to perform operations. The operations comprise: initiating, by a first processor of a first consensus node of a blockchain, a target consensus proposal carrying a first timestamp provided by the first consensus node; receiving, by a second processor of a second consensus node of the blockchain from the first consensus node, the target consensus proposal; determining, by the second processor, a second timestamp based on a time that the target consensus proposal is received; verifying, by the second consensus node, the first timestamp based on a third timestamp of a local ending block of the second consensus node and the second timestamp; in response to successfully verifying the first timestamp, executing, by the second processor, consensus logic on the target consensus proposal to reach a consensus with the first consensus node regarding the target consensus proposal; and generating, by the first processor and the second processor, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

According to a fourth aspect, a non-transitory computer-readable storage medium for block generation is provided. The non-transitory computer-readable storage medium is configured with instructions executable by one or more processors to cause the one or more processors to perform operations. The operations comprise: initiating, by a first processor of a first consensus node of a blockchain, a target consensus proposal carrying a first timestamp provided by the first consensus node; receiving, by a second processor of a second consensus node of the blockchain from the first consensus node, the target consensus proposal; determining, by the second processor, a second timestamp based on a time that the target consensus proposal is received; verifying, by the second consensus node, the first timestamp based on a third timestamp of a local ending block of the second consensus node and the second timestamp; in response to successfully verifying the first timestamp, executing, by the second processor, consensus logic on the target consensus proposal to reach a consensus with the first consensus node regarding the target consensus proposal; and generating, by the first processor and the second processor, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

In the solutions of the embodiments of this specification, when a target consensus node initiates a target consensus proposal, the target consensus proposal carries a first timestamp provided by the target consensus node. After receiving the target consensus proposal, another consensus node performs, based on a second timestamp of a local current moment and a third timestamp of a local ending block, verification on the first timestamp provided by the target consensus node, and after the verification succeeds, executes consensus logic on proposal data of the target consensus proposal. If a consensus is reached, each consensus node generates a new block of a fourth timestamp determined based on the first timestamp, to record the proposal data in the target consensus proposal. The entire solution can effectively ensure that a timestamp of a new block increases progressively with respect to a timestamp of a previous block, so that blocks in a blockchain are in an order of a time dimension, thereby ensuring that some blockchain services requiring time tracing can correctly execute service decisions.

### BRIEF DESCRIPTION OF THE DRAWINGS

To describe the technical solutions in the embodiments of this specification or in the prior art more clearly, the accompanying drawings required for describing the embodiments or the prior art are briefly introduced below. The accompanying drawings in the following description show merely some embodiments of this specification, and a person of ordinary skill in the art may still derive other accompanying drawings from these accompanying drawings without creative efforts.

FIG. 1 is a first schematic flowchart of a method for block generation, according to an embodiment of this specification.

FIG. 2 is a second schematic flowchart of a method for block generation, according to an embodiment of this specification.

FIG. 3 is a schematic structural diagram of a consensus node, according to an embodiment of this specification.

FIG. 4 is a schematic structural diagram of a blockchain system, according to an embodiment of this specification.

FIG. 5 is a schematic structural diagram of an electronic device, according to an embodiment of this specification.

### DETAILED DESCRIPTION

To enable a person skilled in the art to better understand the technical solutions in this specification, the technical solutions of the embodiments of this specification will be described clearly and thoroughly below with reference to the accompanying drawings of the embodiments of this specification. The described embodiments are merely some rather than all of the embodiments of this specification. All other embodiments obtained by a person of ordinary skill in the art based on the embodiments of this specification without creative efforts shall fall within the protection scope of this specification.

As described above, in a blockchain system, timestamps of all blocks need to be sequentially increasing like block numbers. In a current BFT consensus protocol, a timestamp of a block is determined by a proposal initiator. If the proposal initiator is malicious, temporal orderliness of an entire chain of blocks is destroyed. In addition, for some blockchain services that require time tracing, service decisions can be executed only when timestamps of blocks are correct. Under this circumstance, embodiments of this specification provide a technical solution suitable for the BFT consensus protocol to ensure that a timestamp of a new block increases progressively with respect to a timestamp of a previous block.

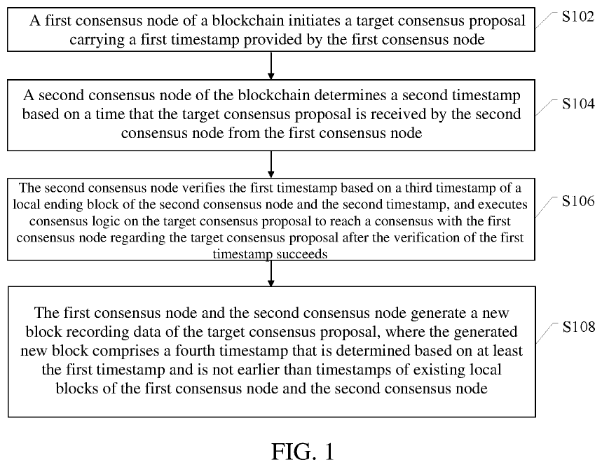

FIG. 1 is a flowchart of a method for block generation, according to an embodiment of this specification. The method shown in FIG. 1 may be performed by a corresponding apparatus below, and includes the following steps.

S102. A first consensus node of a blockchain initiates a target consensus proposal carrying a first timestamp provided by the first consensus node.

Like the conventional BFT consensus protocol, the first consensus node may add the first timestamp proposed by the first consensus node to the target consensus proposal. If a consensus is reached on the target consensus proposal, the first timestamp is used for determining a timestamp of a new block. In this embodiment of this specification, to avoid a malicious behavior of the first consensus node, another node needs to verify the first timestamp subsequently.

S104. A second consensus node of the blockchain determines a second timestamp based on a time that the target consensus proposal is received by the second consensus node from the first consensus node.

For example, after receiving the target consensus proposal, the second consensus node may determine a current timestamp of a local system, and determine the current timestamp as the second timestamp.

S106. The second consensus node verifies the first timestamp based on a third timestamp of a local ending block of the second consensus node and the second timestamp, and executes consensus logic on the target consensus proposal to reach a consensus with the first consensus node regarding the target consensus proposal after the verification of the first timestamp succeeds.

It should be understood that, if the first consensus node provides the first timestamp according to a requirement of sequentially increasing timestamps of blocks, the first timestamp should be later than a timestamp of an ending block of each consensus node and earlier than a time at which another consensus node receives the target consensus proposal. In some embodiments, each of one or more consensus nodes (e.g., the second consensus node) may locally store a complete or partial copy of the blockchain. The locally stored blockchain may comprise a plurality of linked blocks. The local ending block may refer to the block most recently added to the locally stored blockchain or the block in the locally stored blockchain that has the greatest height or the most recent timestamp. Therefore, the second consensus node may verify the first timestamp based on this feature. If the first timestamp is earlier than the second timestamp and later than the third timestamp, the verification succeeds. Otherwise, the verification fails, and the target consensus proposal proposed by the first consensus node may be directly rejected.

S108. The first consensus node and the second consensus node generate a new block recording data of the target consensus proposal, where the generated new block comprises a fourth timestamp that is determined based on at least the first timestamp and is not earlier than timestamps of existing local blocks of the first consensus node and the second consensus node.

Currently, commonly used BFT consensus protocols mainly include a Practical BFT (PBFT) consensus protocol and a Honey Badger BFT consensus protocol.

In the Honey Badger BFT consensus protocol, in each round of consensus, all consensus nodes can initiate a consensus proposal. Therefore, the generated new block comprises a plurality of consensus proposals on which consensuses are reached in a consensus stage of the Honey Badger Byzantine Fault Tolerance algorithm, and records data of all of the plurality of consensus proposals, where the plurality of consensus proposals includes the target consensus proposal and a consensus proposal initialed by the second consensus node. The corresponding fourth timestamp may be determined based on a plurality of timestamps of all the plurality of consensus proposals on which consensuses are reached in the consensus stage, where the plurality of timestamps of all of the plurality of consensus proposals includes the first timestamp. For example, the fourth timestamp is a median value of the timestamps of all the consensus proposals on which a consensus is reached in the consensus stage.

In the PBFT consensus protocol, consensus nodes may be divided into primary consensus nodes and backup consensus nodes. In each round of consensus, only the primary consensus nodes can initiate consensus proposals. Therefore, the fourth timestamp of the generated new block may directly adopt the first timestamp.

Based on the method for block generation shown in FIG. 1, in the solutions of the embodiments of this specification, when a target consensus node initiates a target consensus proposal, the target consensus proposal carries a first timestamp provided by the target consensus node. After the target consensus proposal is received by another consensus node, based on a second timestamp of a local current moment and a third timestamp of a local ending block, another consensus node verifies the first timestamp provided by the target consensus node. After the verification of the first timestamp succeeds, another consensus node executes consensus logic on proposal data of the target consensus proposal to reach a consensus with the target consensus node regarding the target consensus proposal. If a consensus is reached, each consensus node generates a new block with a fourth timestamp that is determined based on the first timestamp and records the proposal data of the target consensus proposal. The entire solution can effectively ensure that a timestamp of a new block increases progressively with respect to a timestamp of a previous block, so that blocks in a blockchain are in an order of a time dimension, thereby ensuring that some blockchain services requiring time tracing can correctly execute service decisions.

The following describes the method for block generation according to the embodiments of this specification in detail.

### Application Scenario 1

In this application scenario 1, a blockchain adopts a Honey Badger BFT consensus protocol. As described above, the Honey Badger BFT consensus protocol requires all consensus nodes to initiate respective consensus proposals in a consensus stage. Therefore, a new block records proposal data of all consensuses proposals on which a consensuses is reached in a current consensus stage, and a timestamp of the new block is determined based on timestamps carried in all consensus proposals on which a consensus is reached.

The Honey Badger BFT consensus protocol includes a reliable broadcast (RBC) protocol stage and a binary agreement (BA) protocol stage. In this application scenario 1, a consensus node verifies a timestamp in a consensus proposal after the RBC protocol stage is completed and before the BA protocol stage is entered. A block generation procedure includes the following steps.

S201. A first consensus node of a blockchain initiates a target consensus proposal carrying a first timestamp in an RBC protocol stage.

In this step, the first consensus node obtains a fifth timestamp related to a current time of a local system and a sixth timestamp of a local ending block. The fifth timestamp related to the current time herein may be a timestamp of the current time, may be a timestamp close to the current time, or may be a timestamp determined based on the current time.

If the fifth timestamp is later than the sixth timestamp, the first consensus node uses the fifth timestamp as the first timestamp, and initiates the target consensus proposal carrying the first timestamp.

If the fifth timestamp is earlier than the sixth timestamp, the first consensus node determines the first timestamp based on a preset rule of adding a unit time T to the sixth timestamp, and initiates the target consensus proposal carrying the first timestamp.

In the RBC protocol stage, each consensus node broadcasts its own consensus proposal to other consensus nodes, and accepts consensus proposals initiated by other consensus nodes. Other consensus proposals (except the target consensus proposal) are not described in detail again herein.

S202. Each consensus node performs a verification procedure of the RBC protocol stage.

In the verification procedure of the RBC protocol stage, each consensus node reconstructs a Merkel tree based on consensus proposal information (that is, echo information) of other consensus nodes, and performs verification on the reconstructed Merkel tree. After the verification succeeds, the consensus node broadcasts a Ready message to other consensus nodes. For any consensus node, after receiving f+1 same Ready messages (where f is a quantity of malicious nodes in a consortium blockchain) from different nodes, the consensus node determines whether the consensus node itself broadcasts any Ready message, and if no, the consensus node broadcasts a Ready message. After receiving 2f+1 same Ready messages from different nodes, the consensus node determines that the consensus node receives correct consensus proposals initiated by other consensus nodes.

S203. After the procedure of the RBC protocol stage is completed, other consensus nodes including a second consensus node determine a second timestamp based on a time that the target consensus proposal is received by other consensus nodes, and obtain a third timestamp based on a local ending block of other consensus nodes.

S204. Other consensus nodes including the second consensus node verify the first timestamp based on the second timestamp and the third timestamp. If the first timestamp is earlier than the second timestamp and later than the third timestamp, the verification succeeds, and S206 is performed. Otherwise, the verification fails, and S205 is performed.

S205. Other consensus nodes including the second consensus node set a BA value of the target consensus proposal in the BA protocol stage to 0.

The target consensus proposal cannot pass this round of consensus when the BA value is 0.

S206. Each consensus node performs a procedure of the BA protocol stage.

A BA protocol is a protocol in which all consensus nodes agree on a single consensus proposal in a cluster. Only a consensus proposal with a BA value of 1 is included in a final consensus result, and proposal data of the consensus protocol can be successfully uploaded to the blockchain.

S207. Each consensus node combines timestamps in all consensus proposals with a BA value of 1 into one set, and determines a median value of all the timestamps in the set as a fourth timestamp.

In addition, if the set is empty due to special reasons, for example, a consensus node provides, in the consensus proposal, a timestamp that can be parsed, the consensus node may alternatively use the third timestamp of the local ending block plus a unit time T as a fourth timestamp of a new block.

S208. Each consensus node generates a new block of the fourth timestamp, where the new block records proposal data of all proposals on which a consensus is reached in a current consensus stage.

### Application Scenario 2

In this application scenario 2, a blockchain adopts a PBFT consensus protocol. As described above, the PBFT consensus protocol requires that only primary consensus nodes can initiate consensus proposals. Therefore, a new block records only proposal data of a consensus proposal initiated by a primary consensus node. If a timestamp provided by the primary consensus node in the consensus proposal is successfully verified, the timestamp provided by the primary consensus node may be directly used as a timestamp of the new block.

Different from the foregoing Honey Badger BFT consensus protocol, the PBFT consensus protocol mainly includes: a pre-prepare stage, a prepare stage, and a commit stage. In this application scenario 2, backup consensus nodes (that is, the foregoing second consensus nodes) verify, in the pre-prepare stage, a first timestamp in a target consensus proposal initiated by the primary consensus node (that is, the foregoing first consensus node).

A block generation procedure includes:

a first consensus node of a blockchain initiates a target consensus proposal carrying a first timestamp.

A consensus process includes:

a pre-prepare stage.

The primary consensus node receives a request from a client, and allocates a number to the request. Then, the primary consensus node broadcasts a pre-prepare message to the backup consensus node. The pre-prepare message includes the number of the request, a view in which the request is located, and a digest of the primary consensus node. In addition, a request for invoking a specified smart contract is broadcasted, and this request indicates an address of the smart contract.

After receiving the pre-prepare message, each backup consensus node determines whether the backup consensus node agrees on the number n allocated by the primary consensus node to the request, that is, confirms whether to accept the pre-prepare message.

If each backup consensus node accepts the pre-prepare message, the backup consensus node invokes the specified smart contract, determines a second timestamp according to logic of the specified smart contract based on a time that the target consensus proposal is received, obtains a third timestamp based on a local ending block, and then verifies the first timestamp based on the second timestamp and the third timestamp.

If the verification succeeds, a prepare stage is entered. If the verification fails, the target consensus proposal is directly returned, and the consensus procedure ends.

### The Prepare Stage

Each of all backup consensus nodes participating in the consensus checks whether a pre-prepare message is legitimate after receiving the pre-prepare message. If the pre-prepare message is legitimate, a state of the consensus proposal on a replica is determined as prepared, and the backup consensus node adds the pre-prepare message to a local log, and sends a prepare message to other backup consensus nodes participating in the consensus.

### A Commit Stage

After entering the prepared state, each of all consensus nodes sends a commit message to the other consensus nodes, and adds the commit message sent by the consensus node itself to a local log (representing approval of the consensus node itself). When a consensus node finds that a quorum (a quorum is a set of a certain quantity of replicas required to meet a requirement for consistency of all replica data and a fault tolerance requirement) agrees to the number allocation, the consensus node broadcasts a commit message to all other nodes. In addition, commit messages from other nodes are received one after another. If each node receives 2f+1 (f is a quantity of malicious nodes in a consortium blockchain) commit messages (including one sent from the node itself, where the commits from different nodes carry a same number n and view v), it indicates that the consensus node has a certificate named committed certificate, and the request reaches a committed state on this consensus node. In this case, it can be determined, merely through this consensus node, that the request has reached a prepared state in a quorum, that is, all consensus nodes of a same quorum agree to allocation of the number n. After the request initiated by the client reaches the committed state, it indicates that a consensus has been reached on an entire network.

### Application Scenario 3

In this application scenario 3, a blockchain adopts a PBFT consensus protocol. Backup consensus nodes (that is, the second consensus nodes described above) verify a first timestamp in a target consensus proposal initiated by a primary consensus node (that is, the first consensus node described above) in a prepare stage. A block generation procedure includes:

a first consensus node of a blockchain initiates a target consensus proposal carrying a first timestamp.

A consensus process includes:

a pre-prepare stage.

The primary consensus node receives a request from a client, and allocates a number to the request. Then, the primary consensus node broadcasts a pre-prepare message to the backup consensus nodes. The pre-prepare message includes the number of the request, a view in which the request is located, and a digest of the primary consensus node.

After receiving the pre-prepare message, each backup consensus node determines whether the backup consensus node agrees on the number n allocated by the primary consensus node to the request, that is, confirms whether to accept the pre-prepare message. If each backup consensus node accepts the pre-prepare message, a prepare stage is entered.

### The Prepare Stage

After receiving the pre-prepare message, each of all backup consensus nodes participating in the consensus invokes a specified smart contract deployed in a consortium blockchain in advance, determines a second timestamp according to logic of the specified smart contract based on a time that the target consensus proposal is received by the backup consensus node, obtains a third timestamp based on a local ending block of the backup consensus node, and then verifies the first timestamp based on the second timestamp and the third timestamp.

If the verification on the first timestamp fails, the current target consensus proposal is directly returned, and the consensus procedure ends.

If the verification succeeds, whether the pre-prepare message is legitimate is checked. If the pre-prepare message is legitimate, a state of the consensus proposal on a replica is determined as prepared, and the backup consensus node adds the pre-prepare message to a local log, and sends a prepare message to other backup consensus nodes.

### A Commit Stage

After entering the prepared state, each of all consensus nodes sends a commit message to the other consensus nodes, and adds, to a local log, the commit message sent by the consensus node itself. When a consensus node finds that a quorum agrees to the number allocation, the consensus node broadcasts a commit message to all other nodes. In addition, commit messages from other nodes are received one after another. If each node receives 2f+1 commit messages, it indicates that the consensus node has a certificate named committed certificate, and the request reaches a committed state on this consensus node. In this case, it can be determined, merely through this consensus node, that the request has reached a prepared state in a quorum, that is, all consensus nodes of a same quorum agree to allocation of the number n. After the request initiated by the client reaches the committed state, it indicates that a consensus has been reached on an entire network.

It can be learned from the foregoing application scenario 2 and application scenario 3 that, in a consensus process of a conventional PBFT algorithm, backup consensus nodes start to execute consensus logic in a pre-prepare stage, that is, the backup consensus nodes check, in the pre-prepare stage, whether a first timestamp sent by a primary consensus node is legitimate. Therefore, a step of service verification performed by the backup consensus nodes may be performed before checking a pre-prepare message. Once a first timestamp fails to pass the verification of the backup consensus nodes, execution of subsequent consensus logic is rejected, thereby avoiding unnecessary resource overheads.

The method according to the embodiments of this specification is introduced as above. It should be understood that appropriate changes can further be made without departing from the foregoing principles herein, and these changes should also be regarded as the protection scope of the embodiments of this specification.

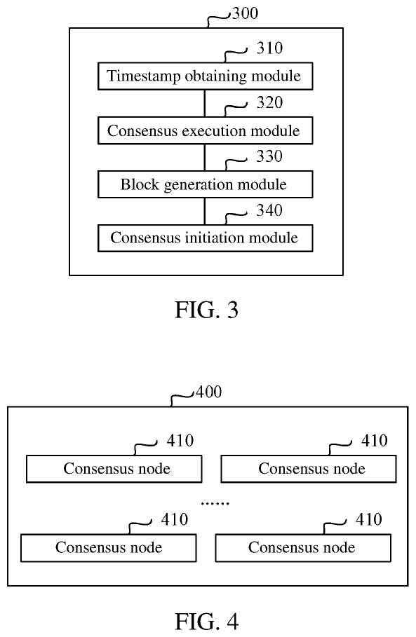

Corresponding to the foregoing method for block generation, an embodiment of this specification further provides a consensus node of a blockchain. FIG. 3 is a schematic structural diagram of a consensus node 300, including:

a timestamp obtaining module 310, configured to determine, after a target consensus proposal initiated by another consensus node of the blockchain is received, a second timestamp based on a time that the target consensus proposal is received, where the target consensus proposal carries a first timestamp provided by the another consensus node;

a consensus execution module 320, configured to perform verification on the first timestamp based on a third timestamp of a local ending block and the second timestamp, to execute consensus logic on proposal data of the target consensus proposal after the verification succeeds;

a block generation module 330, configured to generate, if a consensus is reached on the target consensus proposal, a new block recording the proposal data of the target consensus proposal, where a fourth timestamp of the generated new block is obtained through determining based on at least the first timestamp, and is not earlier than timestamps of other local blocks; and

a consensus initiation module 340, configured to: if a consensus proposal needs to be initiated based on a consensus protocol of the blockchain, initiate a consensus proposal carrying a locally provided timestamp.

When a consensus node in this embodiment of this specification receives a target consensus proposal initiated by another node, the consensus node performs, based on a second timestamp of a local current moment and a third timestamp of a local ending block, verification on a first timestamp provided by the another node and carried in a target consensus proposal, and after the verification succeeds, executes consensus logic on proposal data of the target consensus proposal. If a consensus is reached, a new block of a fourth timestamp determined based on the first timestamp is locally generated, to record the proposal data in the target consensus proposal. The entire solution can effectively ensure that a timestamp of a new block increases progressively with respect to a timestamp of a previous block, so that blocks in a blockchain are in an order of a time dimension, thereby ensuring that some blockchain services requiring time tracing can correctly execute service decisions.

In an embodiment, during execution by the consensus execution module 320, if the first timestamp is earlier than the second timestamp and later than the third timestamp, the verification succeeds. Otherwise, the verification fails.

In an embodiment, during execution by the consensus initiation module 340, a fifth timestamp related to a current time and a sixth timestamp of the local ending block are obtained. If the fifth timestamp is later than the sixth timestamp, a consensus proposal carrying the fifth timestamp is initiated. If the fifth timestamp is earlier than the sixth timestamp, a consensus proposal carrying a seventh timestamp is initiated, where the seventh timestamp is obtained by adding a unit time to the sixth timestamp.

In an embodiment, the blockchain adopts a consensus protocol based on a Honey Badger Byzantine Fault Tolerance algorithm, and a consensus stage to which the target consensus proposal belongs further includes consensus proposals initiated by different other consensus nodes. The generated new block records proposal data of all consensus proposals on which a consensus is reached in the consensus stage, and the fourth timestamp is obtained through determining based on timestamps of all the consensus proposals on which a consensus is reached in the consensus stage, where the timestamps of all the consensus proposals include the first timestamp. For example, the fourth timestamp is a median value of the timestamps of all the consensus proposals on which a consensus is reached in the consensus stage.

In an embodiment, the consensus execution module 320 verifies the first timestamp based on the third timestamp of the local ending block and the second timestamp after an RBC protocol stage of the Honey Badger Byzantine Fault Tolerance algorithm is completed and before a BA protocol stage is entered. In addition, if the first timestamp is not successfully verified, the consensus execution module 320 sets a BA value of the target consensus proposal in the BA protocol stage to 0.

In an embodiment, the blockchain adopts a consensus protocol of a practical Byzantine Fault Tolerance algorithm, the first consensus node is a primary consensus node of the blockchain, and the fourth timestamp is equal to the first timestamp. The consensus execution module 320 may verify the first timestamp in a pre-prepare stage or a prepare stage of the practical Byzantine Fault Tolerance algorithm based on the third timestamp of the local ending block and the second timestamp.

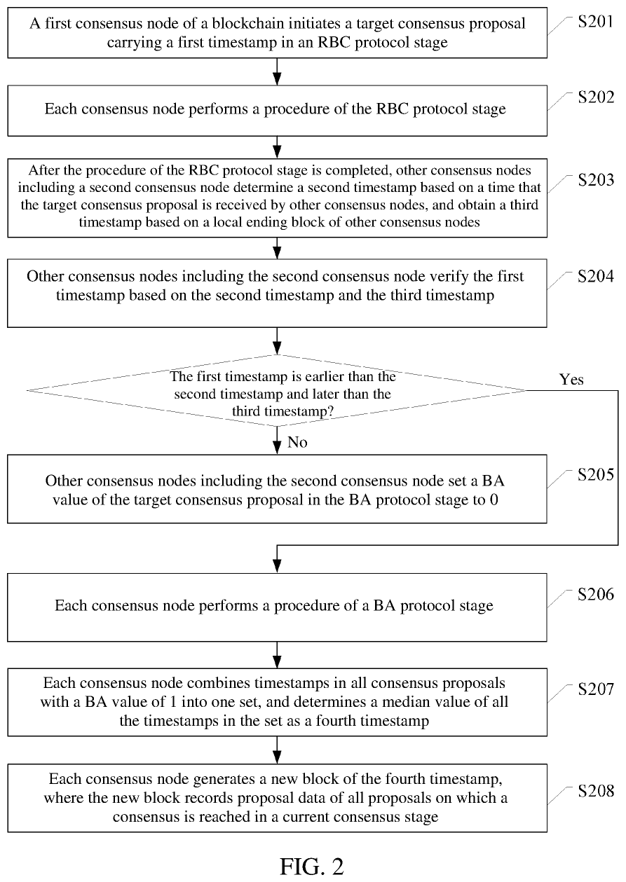

It should be understood that, the consensus node in this embodiment of this specification can serve as an entity for performing the method for block generation shown in FIG. 1, and therefore, can implement the steps and functions of the method for block generation that are implemented in FIG. 1 and FIG. 2. Because the principles are the same, details are not described herein again.

Corresponding to the foregoing method for block generation, an embodiment of this specification further provides a blockchain system/a system for blockchain generation. FIG. 4 is a schematic structural diagram of a blockchain system 400, including a plurality of consensus nodes 410. At least one of the plurality of consensus nodes 410 performs the following steps after receiving a target consensus proposal initiated by another consensus node 410 of a blockchain:

determining a second timestamp based on a time that the target consensus proposal is received, where the target consensus proposal carries a first timestamp provided by the another consensus node; and performing verification on the first timestamp based on a third timestamp of a local ending block and the second timestamp, to execute consensus logic on proposal data of the target consensus proposal after the verification succeeds; and

generating, if a consensus is reached on the target consensus proposal, a new block recording the proposal data of the target consensus proposal, where a fourth timestamp of the generated new block is obtained through determining based on at least the first timestamp, and is not earlier than timestamps of other local blocks; and

if a consensus proposal needs to be initiated based on a consensus protocol of the blockchain, initiating a consensus proposal carrying a locally provided timestamp.

The blockchain system in this embodiment of this specification can implement the steps and functions of the method for block generation shown in FIG. 1. Because the principles are the same, details are not described herein again.

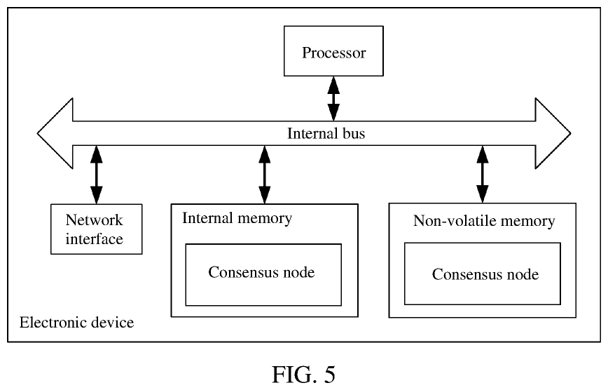

FIG. 5 is a schematic structural diagram of an electronic device, according to an embodiment of this specification. Referring to FIG. 5, in terms of the hardware, the electronic device includes a processor, and optionally includes an internal bus, a network interface, and a memory. The memory may include an internal memory, such as a high-speed random access memory (RAM), and may further include a non-volatile memory, such as at least one disk storage. Definitely, the electronic device may further include hardware required for other services.

The processor, the network interface, and the memory may be connected to each other through an internal bus. The internal bus may be an industry standard architecture (ISA) bus, a peripheral component interconnect (PCI) bus, an extended industry standard architecture (EISA) bus, or the like. The bus may be classified as an address bus, a data bus, a control bus, or the like. For ease of indication, only one bidirectional arrow is used for indication in FIG. 5, but it does not mean that there is only one bus or one type of bus.

The memory is configured to store a program. For example, the program may include a program code. The program code includes a computer operation instruction. The memory may include an internal memory and a non-volatile memory, and provide an instruction and data to the processor.

The processor reads a corresponding computer program from the non-volatile memory into the internal memory and then runs the computer program, to form the consensus node shown in FIG. 3 at a logical level. The processor executes the program stored in the memory and is configured to perform the following operations:

determining, after a target consensus proposal initiated by another consensus node of a blockchain is received, a second timestamp based on a time that the target consensus proposal is received, where the target consensus proposal carries a first timestamp provided by the another consensus node;

performing verification on the first timestamp based on a third timestamp of a local ending block and the second timestamp, to execute consensus logic on proposal data of the target consensus proposal after the verification succeeds;

generating, if a consensus is reached on the target consensus proposal, a new block recording the proposal data of the target consensus proposal, where a fourth timestamp of the generated new block is obtained through determining based on at least the first timestamp, and is not earlier than timestamps of other local blocks; and

if a consensus proposal needs to be initiated based on a consensus protocol of the blockchain, initiating a consensus proposal carrying a locally provided timestamp.

The foregoing method for block generation disclosed in the embodiment shown in FIG. 1 of this specification may be applied to the processor or implemented by the processor. The processor may be an integrated circuit chip, and has a signal processing capability. During implementation, the steps of the foregoing method may be completed through an integrated logic circuit of hardware or an instruction in the form of software in the processor. The foregoing processor may be a general-purpose processor, including a central processing unit (CPU), a network processor (NP), or the like; and may further be a digital signal processor (DSP), an application specific integrated circuit (ASIC), a field-programmable gate array (FPGA), or other programmable logic devices, a discrete gate or a transistor logic device, or a discrete hardware component. The methods, steps, and logical block diagrams disclosed in the embodiments of this specification may be implemented or performed. The general-purpose processor may be a microprocessor, or the processor may be any conventional processor and the like. The steps of the method disclosed in combination with the embodiments of this specification may be directly embodied as being performed by a hardware decoding processor, or performed by a combination of hardware and software modules in the decoding processor. The software module may be stored in a storage medium that is mature in the art, such as a random access memory (RAM), a flash memory, a read-only memory (ROM), a programmable ROM, an electrically erasable programmable memory, or a register. The storage medium is located in the memory. The processor reads information in the memory and completes the steps of the foregoing methods in combination with hardware thereof.

It should be understood that the electronic devices according to the embodiments of this specification can implement the functions of the embodiments of the consensus node shown in FIG. 1 and FIG. 2. Because the principles are the same, details are not described herein again.

Definitely, in addition to the software implementation, the electronic device of this specification does not exclude other implementations, such as a logic device or a combination of software and hardware. In other words, an entity for performing the following processing flow is not limited to each logic unit, but further limited to the hardware or logic device.

In addition, an embodiment of this specification further proposes a computer-readable storage medium storing one or more programs. The one or more programs include an instruction. When the instruction is executed by a portable electronic device including a plurality of application programs, the portable electronic device can perform the method for block generation shown in the embodiment of FIG. 1 and can be configured to perform the following steps:

determining, after a target consensus proposal initiated by another consensus node of a blockchain is received, a second timestamp based on a time that the target consensus proposal is received, where the target consensus proposal carries a first timestamp provided by the another consensus node;

performing verification on the first timestamp based on a third timestamp of a local ending block and the second timestamp, to execute consensus logic on proposal data of the target consensus proposal after the verification succeeds;

generating, if a consensus is reached on the target consensus proposal, a new block recording the proposal data of the target consensus proposal, where a fourth timestamp of the generated new block is obtained through determining based on at least the first timestamp, and is not earlier than timestamps of other local blocks; and

if a consensus proposal needs to be initiated based on a consensus protocol of the blockchain, initiating a consensus proposal carrying a locally provided timestamp.

It should be understood that, when the foregoing instruction is executed by the portable electronic device that includes the plurality of application programs, for the consensus node described above to implement the functions of the embodiments shown in FIG. 1 and FIG. 2. Because the principles are the same, details are not described herein again.

A person skilled in the art should understand that the embodiments of this specification may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a CD-ROM, an optical memory, and the like) that include computer-usable program code.

Embodiments of this specification are described above. Other embodiments fall within the scope of the appended claims. In some embodiments, the actions or steps recorded in the claims may be performed in sequences different from those in the embodiments and an expected result may still be achieved. In addition, the processes depicted in the accompanying drawings is not necessarily performed in the specific order or successively to achieve an expected result. In some implementations, multitasking and parallel processing may be feasible or beneficial.

The descriptions are merely embodiments of this application, and do not limit the embodiments of this application. For a person skilled in the art, various modifications and changes may be made to this application. Any modifications, equivalent replacements, and improvements made within the spirit and principle of this application shall fall within the scope of the claims of this application. In addition, all other embodiments obtained by a person of ordinary skill in the art without creative efforts shall fall within the protection scope of this specification.

What is claimed is:

1. A method for block generation, comprising:
initiating, by a first consensus node of a blockchain, a target consensus proposal carrying a first timestamp provided by the first consensus node;
receiving, by a second consensus node of the blockchain from the first consensus node, the target consensus proposal;
determining, by the second consensus node, a second timestamp based on a time that the target consensus proposal is received;
verifying, by the second consensus node, the first timestamp based on a third timestamp of a local ending block of the second consensus node and the second timestamp;
in response to successfully verifying the first timestamp, executing, by the second consensus node, consensus logic on the target consensus proposal to reach a consensus with the first consensus node regarding the target consensus proposal; and
generating, by the first consensus node and the second consensus node, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

2. The method according to claim 1, wherein the initiating, by a first consensus node of a blockchain, a target consensus proposal carrying a first timestamp provided by the first consensus node comprises:
obtaining, by the first consensus node, a fifth timestamp related to a current time and a sixth timestamp of a local ending block of the first consensus node; and
if the fifth timestamp is later than the sixth timestamp, using the fifth timestamp as the first timestamp and initiating the target consensus proposal carrying the first timestamp, or
if the fifth timestamp is earlier than the sixth timestamp, determining the first timestamp by adding a unit time to the sixth timestamp and initiating the target consensus proposal carrying the first timestamp.

3. The method according to claim 1, wherein the verifying, by the second consensus node, the first timestamp comprises:
verifying that the first timestamp is earlier than the second timestamp and later than the third timestamp.

4. The method according to claim 1, wherein:
the first consensus node and the second consensus node adopt a consensus protocol based on a Honey Badger Byzantine Fault Tolerance algorithm;
the generated new block comprises a plurality of consensus proposals on which consensuses are reached in a consensus stage of the Honey Badger Byzantine Fault Tolerance algorithm, the plurality of consensus proposals including the target consensus proposal and a consensus proposal initialed by the second consensus node; and
the fourth timestamp is determined based on a plurality of timestamps of the plurality of consensus proposals, the plurality of timestamps comprising the first timestamp.

5. The method according to claim 4, wherein:
the fourth timestamp is a median value of the plurality of timestamps.

6. The method according to claim 4, wherein:
the verifying, by the second consensus node, the first timestamp occurs after a reliable broadcast (RBC) protocol stage of the Honey Badger Byzantine Fault Tolerance algorithm is completed and before a binary agreement (BA) protocol stage is entered.

7. The method according to claim 4, further comprising:
in response to the first timestamp not being successfully verified, setting, by the second consensus node, a BA value of the target consensus proposal in a BA protocol stage to 0 to cause a failure to reach a consensus on the target consensus proposal.

8. The method according to claim 1, wherein:
the blockchain adopts a consensus protocol of a Practical Byzantine Fault Tolerance algorithm;
the first consensus node is a primary consensus node of the blockchain; and
the fourth timestamp is equal to the first timestamp.

9. The method according to claim 8, wherein:
the verifying, by the second consensus node, the first timestamp occurs in a pre-prepare stage or a prepare stage of the practical Byzantine Fault Tolerance algorithm.

10. A system for block generation, comprising one or more processors and a non-transitory computer-readable storage medium storing instructions executable by the one or more processors to cause the system to perform operations comprising:
initiating, by a first processor of a first consensus node of a blockchain, a target consensus proposal carrying a first timestamp provided by the first consensus node;
receiving, by a second processor of a second consensus node of the blockchain from the first consensus node, the target consensus proposal;
determining, by the second processor, a second timestamp based on a time that the target consensus proposal is received;
verifying, by the second consensus node, the first timestamp based on a third timestamp of a local ending block of the second consensus node and the second timestamp;
in response to successfully verifying the first timestamp, executing, by the second processor, consensus logic on the target consensus proposal to reach a consensus with the first consensus node regarding the target consensus proposal; and
generating, by the first processor and the second processor, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

11. The system according to claim 10, wherein the initiating, by a first processor of a first consensus node of a blockchain, a target consensus proposal carrying a first timestamp provided by the first consensus node comprises:
obtaining, by the first processor, a fifth timestamp related to a current time and a sixth timestamp of a local ending block of the first consensus node; and
if the fifth timestamp is later than the sixth timestamp, using the fifth timestamp as the first timestamp and initiating the target consensus proposal carrying the first timestamp, or
if the fifth timestamp is earlier than the sixth timestamp, determining the first timestamp by adding a unit time to the sixth timestamp and initiating the target consensus proposal carrying the first timestamp.

12. The system according to claim 10, wherein the verifying, by the second processor, the first timestamp comprises:
verifying that the first timestamp is earlier than the second timestamp and later than the third timestamp.

13. The system according to claim 10, wherein:
the first consensus node and the second consensus node adopt a consensus protocol based on a Honey Badger Byzantine Fault Tolerance algorithm;
the generated new block comprises a plurality of consensus proposals on which consensuses are reached in a consensus stage of the Honey Badger Byzantine Fault Tolerance algorithm, the plurality of consensus proposals including the target consensus proposal and a consensus proposal initialed by the second processor; and
the fourth timestamp is determined based on a plurality of timestamps of the plurality of consensus proposals, the plurality of timestamps comprising the first timestamp.

14. The system according to claim 13, wherein:
the verifying, by the second processor, the first timestamp occurs after a reliable broadcast (RBC) protocol stage of the Honey Badger Byzantine Fault Tolerance algorithm is completed and before a binary agreement (BA) protocol stage is entered.

15. The system according to claim 10, wherein:
the blockchain adopts a consensus protocol of a Practical Byzantine Fault Tolerance algorithm;
the first consensus node is a primary consensus node of the blockchain; and
the fourth timestamp is equal to the first timestamp.

16. A non-transitory computer-readable storage medium for block generation, configured with instructions executable by one or more processors to cause the one or more processors to perform operations comprising:
initiating, by a first processor of a first consensus node of a blockchain, a target consensus proposal carrying a first timestamp provided by the first consensus node;
receiving, by a second processor of a second consensus node of the blockchain from the first consensus node, the target consensus proposal;
determining, by the second processor, a second timestamp based on a time that the target consensus proposal is received;
verifying, by the second processor, the first timestamp based on a third timestamp of a local ending block of the second consensus node and the second timestamp;
in response to successfully verifying the first timestamp, executing, by the second processor, consensus logic on the target consensus proposal to reach a consensus with the first consensus node regarding the target consensus proposal; and
generating, by the first processor and the second processor, a new block recording data of the target consensus proposal, wherein the generated new block comprises a fourth timestamp, and the fourth timestamp is determined based on at least the first timestamp and is not earlier than timestamps of existing local blocks the first consensus node and the second consensus node.

17. The medium according to claim 16, wherein the initiating, by a first processor of a first consensus node of a blockchain, a target consensus proposal carrying a first timestamp provided by the first consensus node comprises:
obtaining, by the first processor, a fifth timestamp related to a current time and a sixth timestamp of a local ending block of the first consensus node; and
if the fifth timestamp is later than the sixth timestamp, using the fifth timestamp as the first timestamp and initiating the target consensus proposal carrying the first timestamp, or
if the fifth timestamp is earlier than the sixth timestamp, determining the first timestamp by adding a unit time to the sixth timestamp and initiating the target consensus proposal carrying the first timestamp.

18. The medium according to claim 16, wherein the verifying, by the second processor, the first timestamp comprises:
verifying that the first timestamp is earlier than the second timestamp and later than the third timestamp.

19. The medium according to claim 16, wherein:
the first consensus node and the second consensus node adopt a consensus protocol based on a Honey Badger Byzantine Fault Tolerance algorithm;
the generated new block comprises a plurality of consensus proposals on which consensuses are reached in a consensus stage of the Honey Badger Byzantine Fault Tolerance algorithm, the plurality of consensus proposals including the target consensus proposal and a consensus proposal initialed by the second processor; and
the fourth timestamp is determined based on a plurality of timestamps of the plurality of consensus proposals, the plurality of timestamps comprising the first timestamp.

20. The medium according to claim 16, wherein:
the blockchain adopts a consensus protocol of a Practical Byzantine Fault Tolerance algorithm;
the first consensus node is a primary consensus node of the blockchain; and
and the fourth timestamp is equal to the first timestamp.
